(19) United States
(12) Patent Application Publication
(10) Pub. No.: US 2021/0326446 A1
(43) Pub. Date: Oct. 21, 2021

(54) Vulnerability Detection Method, Apparatus, Electronic Device and Storage Medium

(71) Applicant: Baidu Online Network Technology (Beijing) CO,Ltd,, Beijing (CN)

(72) Inventors: Xinyu Cao, Beijing (CN); Youyi Tang, Beijing (CN); Xinkai Li, Beijing (CN); Yi Pei, Beijing (CN); Menghan Gao, Beijing (CN)

(21) Appl. No.: 17/209,553

(22) Filed: Mar. 23, 2021

(30) Foreign Application Priority Data
Jul. 20, 2020 (CN) 202010700434.8

(51) Int. Cl. G06F 21/57

(52) U.S. Cl. CPC G06F 21/577; G06F 2221/034

(57) ABSTRACT

The present application discloses a vulnerability detection method and apparatus, an electronic device and a storage medium, and relates to the field of vulnerability processing and the like. The specific implementation is as follows: implanting an agent into a target object, and performing, by the agent, preprocessing of taint tracking on actual running information of the target object, to obtain target running information to be loaded after the preprocessing; executing the target running information till a taint monitoring point for the taint tracking, to obtain taint information and probe information; and transmitting the taint information and the probe information to a scanning end, to construct, at the scanning end, a vulnerability detection request for vulnerability detection, according to the taint information and the probe information.

### CROSS-REFERENCE TO RELATED APPLICATION

This application claims priority to Chinese patent application No. 202010700434.8, filed on Jul. 20, 2020, which is hereby incorporated by reference in its entirety.

### TECHNICAL FIELD

The present application relates to the field of information security processing. The present application relates in particular to the field of vulnerability processing, and can be applied to the fields of taint information tracking, vulnerability detection, vulnerability scanning, vulnerability early warning, vulnerability repairing related to vulnerability and the like.

### BACKGROUND

With the development of the Internet technology, the communication technology and the terminal intellectualization, information leakage events frequently occur in this era in which a large amount of information interactions are required every day. Since information security concerns the privacy of each enterprise user and private user, it is necessary to strengthen the processing of the information security.

The information security has a very important safeguard function in the development of the Internet technology, the communication technology and the terminal intellectualization.

### SUMMARY

The present application provides a vulnerability detection method and apparatus, an electronic device and a storage medium.

According to an aspect of the present application, there is provided a vulnerability detection method, including:

implanting an agent into a target object, and performing, by the agent, preprocessing of taint tracking on actual running information of the target object, to obtain target running information to be loaded after the preprocessing;

executing the target running information till a taint monitoring point for the taint tracking, to obtain taint information and probe information; and

transmitting the taint information and the probe information to a scanning end, to construct, at the scanning end, a vulnerability detection request for vulnerability detection, according to the taint information and the probe information.

According to another aspect of the present application, there is provided a vulnerability detection method, including:

receiving taint information and probe information, the taint information and the probe information being obtained from monitoring by an agent implanted into a target object;

constructing a vulnerability detection request for vulnerability detection according to the taint information and the probe information; and

transmitting the vulnerability detection request.

According to another aspect of the present application, there is provided a vulnerability detection apparatus, including:

a preprocessing module configured to implant an agent into a target object, and perform, by the agent, preprocessing of taint tracking on actual running information of the target object, to obtain target running information to be loaded after the preprocessing;

a tracking module configured to execute the target running information till a taint monitoring point for the taint tracking, to obtain taint information and probe information; and

a transmitting module configured to transmit the taint information and the probe information to a scanning end, to construct, at the scanning end, a vulnerability detection request for vulnerability detection, according to the taint information and the probe information.

According to another aspect of the present application, there is provided a vulnerability detection apparatus, including:

an information receiving module configured to receive taint information and probe information, the taint information and the probe information being obtained from monitoring by an agent implanted into a target object;

a request constructing module configured to construct a vulnerability detection request for vulnerability detection according to the taint information and the probe information; and

a request transmitting module configured to transmit the vulnerability detection request.

According to another aspect of the present application, there is provided an electronic device, including:

at least one processor; and

a memory communicatively connected to the at least one processor,

wherein the memory stores instructions which are executable by the at least one processor to enable the at least one processor to perform the method provided by any one of the embodiments of the present application.

According to another aspect of the present application, there is provided a non-transitory computer-readable storage medium storing computer instructions for enabling a computer to perform the method provided by any one of the embodiments of the present application.

It should be understood that the content described in this section is intended neither to identify the key or important features of the embodiments of the present application, nor to limit the scope of the present application. Other features of the present application will be easily understood from the following description.

### BRIEF DESCRIPTION OF THE DRAWINGS

The accompanying drawings are provided for better understanding of the present application, rather than limiting the present application. In which:

FIG. 1 is a schematic flowchart of a vulnerability detection method according to an embodiment of the present application;

FIG. 2 is a schematic flowchart of a vulnerability detection method according to an embodiment of the present application;

FIG. 3 is a schematic diagram of intercepting and implanting a taint marking operation at an agent end according to an embodiment of the present application;

FIG. 4 is a schematic diagram of bytecode parsing and replacement at an agent end according to an embodiment of the present application;

FIG. 5 is a schematic diagram of an interaction between an agent end and a scanning end according to an embodiment of the present application;

FIG. 6 is a schematic structural diagram of a vulnerability detection apparatus according to an embodiment of the present application;

FIG. 7 is a schematic structural diagram of a vulnerability detection apparatus according to an embodiment of the present application; and

FIG. 8 is a block diagram of an electronic device for implementing a vulnerability detection method according to an embodiment of the present application.

### DETAILED DESCRIPTION OF THE EMBODIMENTS

Exemplary embodiments of the present application are described below in combination with the accompanying drawings, including various details of the embodiments of the present application to facilitate the understanding, and they should be considered as merely exemplary. Thus, it should be realized by those of ordinary skill in the art that various changes and modifications can be made to the embodiments described here without departing from the scope and spirit of the present application. Also, for the sake of clarity and conciseness, the contents of well-known functions and structures are omitted in the following description.

Herein the term ‘and/or’ is only an association relationship describing associated objects, and there may be three relationships. For example, A and/or B may mean three cases that A exists alone, A and B exist at the same time, and B exists alone. Herein the term ‘at least one’ means any one of a plurality of terms, or any combination of at least two thereof. For example, ‘comprising at least one of A, B and C’ may mean including any one or more elements selected from a set consisting of A, B and C. Herein the terms ‘first’ and ‘second’ refer to and distinguish between a plurality of similar technical terms, rather than limiting an order thereof or limiting that the number thereof is only two. For example, a first feature and a second feature refer to two types of features/two features, the first feature may be one or more, and the second feature may also be one or more.

In addition, in order to better explain the present application, numerous specific details are given in the following embodiments. Those skilled in the art should understand that the present application can also be implemented without certain details. In some examples, methods, means, elements and circuits well known to those skilled in the art are not described in detail, in order to highlight the main idea of the present application.

In terms of the security of a website, attacks on the website are generally called as injection attacks, one purpose of which is to illegally acquire the control right of the website. The attack operation can be carried out against security vulnerabilities at a database level of the website. The attack operation on a website may be directed against a browser webpage which can access the website or an Internet (WEB) application which can access the website. If there is any security vulnerability, the attack operation is very likely to be mistaken for a normal operation instruction and executed by a library, resulting in a theft, an alteration or a deletion of website information (e.g., information of a login account of a user who logs in the website), and even an implantation of malicious codes, etc.

It is necessary to detect the possible security vulnerabilities to strengthen the information security. However, there is no effective solution in the related arts.

Taking the information security for websites as an example, for an attack on a website, an interactive vulnerability detection technology may be adopted to detect vulnerabilities, which for example may be implemented by an interaction between an end for a target object to be detected (e.g., a WEB application end) and the other end (e.g., a scanning end that initiates a vulnerability detection request).

The vulnerability detection for a WEB application (e.g., a WEB application developed in Java) may be supported by the interactive vulnerability detection technology. Since the WEB application may generate a vulnerability that can be invaded and utilized by hackers in a development stage, after the WEB application is developed, it is necessary to adopt the interactive vulnerability detection technology to trigger the scanning of the WEB application through the constructed vulnerability detection request in a testing stage before the WEB application is recommended to a user (e.g., an enterprise user or a private user) for use, so as to implement vulnerability detection of the WEB application.

For the vulnerability detection of the WEB application, there is a respective problem whether a black-box blind scanning method, a static code-based white-box scanning method, or a probe-based interactive scanning method is adopted to detect the vulnerability. The specific description is as follows:

(1) The black-box blind scanning method is adopted to detect the vulnerability. This method requires the WEB application to be scanned by configuring the access address of the WEB application in combination with a crawler. In a case where the internal running information of the WEB application cannot be obtained, a vulnerability detection request is constructed to simulate an attack request, and it is determined whether a vulnerability is existed through a feedback from the WEB application for the vulnerability detection request.

Since this method conducts an exploratory vulnerability detection from the outside of the WEB application, it is impossible to know running information inside the WEB application (e.g., the context information when the WEB application is running), such that a corresponding vulnerability detection request cannot be given in a targeted way for a vulnerability that may occur inside the WEB application. As a result, only blind scanning is performed, which leads to poor detection effects of the vulnerability detection, for example, a low processing efficiency, long processing time and a low vulnerability detection ratio. Moreover, even if a vulnerability can be found, the given vulnerability information is also very limited and not sufficient enough because the running information (e.g., the stack information during running) of the WEB application cannot be given, so it is difficult to locate and repair the vulnerability. In this method, the access addresses of the WEB application needs to be collected, which relies on additional operations such as the user configuration, the conjunction of crawlers and the browser plugging in, etc. The collection of the access addresses is not only complicated but also incomplete, which will further affect the detection effect of the vulnerability detection.

(2) The static code-based white-box scanning method is adopted to detect the vulnerability. This method requires performing scanning, and analyzing the static codes of the WEB application, so as to find the existing vulnerabilities and potential risks.

This method only needs to scan the user code statically, thus there is no need to deploy the specific WEB application environment. That is to say, this method cannot analyze the static code in combination with the real running environment together, thereby causing poor detection effects of the vulnerability detection, for example, a high vulnerability false alarm rate, a low vulnerability detection ratio and high difficulty in vulnerability repairing.

(3) The probe-based interactive scanning method is adopted to detect the vulnerability. This method uses an independent agent such as an agent process to invade into the WEB application, so as to implant a probe dynamically. A running state of the WEB application is analyzed at a key calling point of the WEB application, in conjunction with the probe context information during running of the WEB application, and running information is fed back to a scanning end, so that the scanning end can construct a scanning request in a targeted manner according to the running information, thereby realizing the vulnerability detection.

This method merely relies on the probe information, and cannot track the pollution process of the pollution information inside the WEB application. Thus, the scanning end cannot construct a targeted vulnerability detection request for the tracking of the pollution information, thereby causing poor detection effects of the vulnerability detection, for example, a low processing efficiency of the vulnerability detection and high difficulty in vulnerability repairing.

In an application scenario of the present application, an agent (e.g., an agent process executed together with a WEB application process) may be implanted into a target object (e.g., a browser webpage or a WEB application which can access a website), and an interactive vulnerability detection may be realized through an agent end and the other end (the scanning end that initiates a vulnerability detection request). At the agent end, preprocessing of taint tracking is performed on an original bytecode instruction to be loaded and run, such as adding a taint marking operation into the original bytecode instruction, to obtain a new bytecode instruction after the preprocessing. Next, the new bytecode instruction is loaded and run, and when running till a taint monitoring point for the taint tracking, the obtained taint information (e.g., corresponding taint information tracked by the probe) and probe information (e.g., the probe context information, which may be combined to track the corresponding taint information) is transmitted to the scanning end. After receiving the taint information and the probe information, the scanning end may construct a vulnerability detection request for the vulnerability detection according to the taint information and the probe information. Since the taint information and the probe information for constructing the vulnerability detection request are obtained from monitoring by the agent implanted into the target object, the running information inside the target object not only can be obtained, but also can be analyzed together with the real running environment where the target object is loaded. The probe can also track the possible pollution process of the taint information inside the target object. Therefore, the vulnerability detection request constructed by the scanning end according to the taint information and the probe information is more targeted for the vulnerability detection, and enables to easily locate a vulnerability and further repair the vulnerability, thereby improving the detection effect of the vulnerability detection. For example, the improved detection effect of the vulnerability detection may include a high processing efficiency, short processing time, a large vulnerability detection ratio, a high vulnerability detection accuracy, low difficulty in vulnerability repairing, and the like.

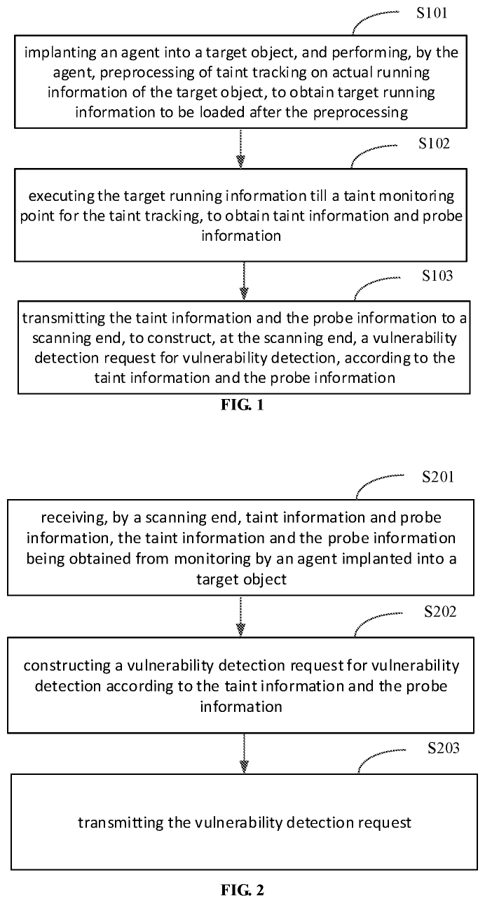

According to an embodiment of the present application, there is provided a vulnerability detection method. FIG. 1 is a schematic flowchart of a vulnerability detection method according to an embodiment of the present application, and this vulnerability detection method can be applied to a vulnerability detection apparatus. For example, in a case where this vulnerability detection apparatus may be deployed in a terminal or a server or other processing apparatus, the vulnerability detection apparatus can implant an agent into a target object, perform taint tracking, acquire taint information and probe information, and transmit the taint information and the probe information to construct a vulnerability detection request for vulnerability detection, and so on. Herein, the terminal may be a User Equipment (UE), a mobile device, a cellular phone, a cordless phone, a Personal Digital Assistant (PDA), a handheld device, a computing device, a vehicle-mounted device, a wearable device, etc. In some possible implementations, this vulnerability detection method may also be implemented by calling computer-readable instructions stored in a memory by a processor. As illustrated in FIG. 1, the vulnerability detection method may include:

S101, implanting an agent into a target object, and performing, by the agent, preprocessing of taint tracking on actual running information of the target object, to obtain target running information to be loaded after the preprocessing.

In an example, the target object may be, for example, a browser webpage or a target WEB application which can access a website, or the like. Herein, the browser webpage may be triggered to be displayed by a browsing operation of the target WEB website or the target WEB application.

In an example, the agent may be implemented by being implanted into the target object, and an Agent process may be run together with a WEB application process. The ‘agent’ in the present application is not limited thereto, as long as the agent end can perform an interactive vulnerability detection with the scanning end, which is within the protection scope of the present application. For example, the agent may also be an independent application capable of running an agent process, i.e., an application running the agent process, and may be deployed separately from the WEB application while associated therewith, to monitor the taint tracking according to the agent. For another example, the agent may also be a hardware entity capable of running the agent process, and may be deployed separately from the WEB application while associated therewith, to monitor the taint tracking according to the agent.

In an example, the actual running information of the target object may be a dynamic code to be loaded, such as an original bytecode instruction.

In an example, the preprocessing of taint tracking may be an implanted taint tracking operation, such as the preprocessing that adds a taint marking operation into the original bytecode instruction. The taint marking operation may be adopted to dynamically track a transfer process (or called as a pollution process) of the taint information inside the target object. After the preprocessing of taint tracking is performed on the original bytecode instruction to be loaded and run, a new bytecode instruction after the preprocessing can be obtained.

S102, executing the target running information till a taint monitoring point for the taint tracking, to obtain taint information and probe information.

In an example, the taint information may be corresponding taint information tracked by a probe, or it may be irrelevant to the probe, but just taint information in a transfer process inside the target object.

In an example, the probe information may at least include probe context information, and in a case where the probe is related to the taint information, the corresponding taint information may be tracked in combination with the probe context information.

S103, transmitting the taint information and the probe information to a scanning end, to construct, at the scanning end, a vulnerability detection request for vulnerability detection, according to the taint information and the probe information.

By adopting the present application, an agent may be implanted into a target object (e.g., a browser webpage or a WEB application program which can access a website), and preprocessing of taint tracking may be performed on actual running information of the target object by the agent, to obtain target running information to be loaded after the preprocessing. By executing the target running information till a taint monitoring point for the taint tracking, taint information and probe information may be obtained, and then transmitted to a scanning end by the agent. Since the taint information and the probe information are obtained from monitoring by the agent, after receiving the taint information and the probe information, the scanning end can perform a targeted vulnerability detection on possible security vulnerabilities in the target object according to a vulnerability detection request constructed by the taint information and the probe information, thereby improving the detection effect of the vulnerability detection.

The improved detection effect of the vulnerability detection may include, for example, a high processing efficiency, short processing time, a high vulnerability detection ratio, a high vulnerability detection accuracy, low difficulty in vulnerability repairing and the like.

According to an embodiment of the present application, there is provided a vulnerability detection method. FIG. 2 is a schematic flowchart of a vulnerability detection method according to an embodiment of the present application, and this vulnerability detection method can be applied to a vulnerability detection apparatus. As illustrated in FIG. 2, the vulnerability detection method may include:

S201, receiving, by a scanning end, taint information and probe information, the taint information and the probe information being obtained from monitoring by an agent implanted into a target object.

In an example, the taint information may be corresponding taint information tracked by a probe, or it may be irrelevant to the probe, but just taint information in a transfer process inside the target object.

In an example, the probe information may at least include probe context information, and in a case where the probe is related to the taint information, the corresponding taint information may be tracked in combination with the probe context information.

In an example, the agent may be implemented by being implanted into the target object, and an Agent process may be run together with a WEB application process. The ‘agent’ in the present application is not limited thereto, as long as the agent end can perform an interactive vulnerability detection with the scanning end, which is within the protection scope of the present application. For example, the agent may also be an independent application capable of running an agent process, i.e., an application running the agent process, and may be deployed separately from the WEB application while associated therewith, to monitor the taint tracking according to the agent.

For another example, the agent may also be a hardware entity capable of running the agent process, and may be deployed separately from the WEB application while associated therewith, to monitor the taint tracking according to the agent. Through the taint information and the probe information obtained from monitoring by the agent, the scanning end can construct a vulnerability detection request in a more targeted manner.

In an example, the scanning end may exist as a test terminal for performing the vulnerability detection on the target object, or the scanning end may exist as a test platform for performing the vulnerability detection on the target object, and this test platform may be located on a server side.

S202, constructing a vulnerability detection request for vulnerability detection according to the taint information and the probe information.

S203: transmitting the vulnerability detection request.

According to the present application, the scanning end can construct a vulnerability detection request for vulnerability detection according to the received taint information and probe information. Since the taint information and the probe information may be obtained from monitoring by the agent implanted into the target object, the constructed vulnerability detection request is more targeted, thereby improving the detection effect of the vulnerability detection. The improved detection effect of the vulnerability detection may include, for example, a high processing efficiency, short processing time, a high vulnerability detection ratio, a high vulnerability detection accuracy, low difficulty in vulnerability repairing and the like.

In an embodiment, a load parameter for a detection of a specified vulnerability type may also be added into the vulnerability detection request, to obtain and transmit a first vulnerability detection request. Upon receiving the first vulnerability detection request, the agent may obtain the load parameter by parsing the first vulnerability detection request, thereby triggering the detection of the specified vulnerability type according to the load parameter.

In a case where the load parameter for the detection of the specified vulnerability type is added into the vulnerability detection request, the load parameter, such as a payload factor for the specified vulnerability type, may be used to trigger relevant detection of a specified vulnerability, such as giving a specific pollution process of a payload in the vulnerability so that repairing of the vulnerability is simpler and easier, or may be used to verify in a targeted manner whether this specified vulnerability can be triggered by the vulnerability detection request, to realize a targeted vulnerability detection on the specified vulnerability type. Further, since the vulnerability detection is made for the specified vulnerability type, the detection range is narrowed. Therefore, not only the targeted vulnerability type detection has a higher accuracy, but also the scanning for the vulnerability detection is faster, which makes the processing efficiency of the vulnerability detection higher.

Based on the interactive detection between the agent implanted into the target object and the scanning end, the agent may obtain the taint information and the probe information by performing the preprocessing and monitoring of the taint tracking, and transmit the taint information and the probe information to the scanning end. The vulnerability detection request constructed by the scanning end according to the taint information and the probe information is more targeted for the vulnerabilities of the target object. After the scanning end transmits the vulnerability detection request to the agent, the detection of vulnerability scanning can be performed on the target object by the agent, to obtain a feedback of the vulnerability detection request. After receiving the feedback of the vulnerability detection request, the scanning end can obtain a vulnerability detection result from the feedback of the vulnerability detection request.

In an embodiment, the performing, by the agent, the preprocessing of taint tracking on actual running information of the target object, to obtain target running information to be loaded after the preprocessing, may include: intercepting the actual running information of the target object before the actual running information of the target object is loaded, and adding a taint marking operation into the actual running information of the target object, to obtain the target running information.

According to this embodiment, it is possible to implement the preprocessing on the target running information to be loaded by intercepting and adding the taint marking operation, thereby enabling the taint tracking of the taint information to be realized.

In an embodiment, the adding the taint marking operation into the actual running information of the target object, to obtain the target running information, may include: acquiring key calling points in a class method contained in the actual running information of the target object, and replacing byte code instructions of the key calling points with the taint marking operation to obtain the target running information. Herein, the key calling point may include a calling point of at least one of a string operation, an encryption and decryption operation, a codec operation and a stream processing operation.

According to this embodiment, since the processing (e.g., a processing such as calling, modification, etc.) is performed on the key calling point that is called in the class method, rather than on the calling method itself, it solves the difficulty in the taint tracking for the Java interface calling, avoids the situation that the tracking cannot be performed unless the Java interface operation finds all implementation classes inherited by a certain interface, and reduces the difficulty in the taint tracking and the probe implantation.

In an embodiment, the transfer process of the taint information inside the target object is tracked through the taint marking operation to monitor the vulnerabilities in the taint information.

According to this embodiment, the transfer process of the taint information inside the target object may be tracked through the taint marking operation, thereby realizing the vulnerability monitoring of the vulnerabilities in the taint information.

In an embodiment, the executing the target running information till the taint monitoring point for the taint tracking, to obtain taint information and probe information, may include: executing the target running information till the taint monitoring point for the taint tracking, to acquire the taint marking operation, and parsing the taint marking operation to obtain the taint information and the probe information.

Herein, the taint marking operation is parsed to trigger a taint tracking processing and obtain the taint information, and when the taint tracking processing is performed till a probe, the probe information is acquired.

According to this embodiment, the taint tracking processing may be triggered by parsing the taint marking operation, to obtain the taint information, and when the taint tracking processing is performed till a probe, the probe information may be acquired, thereby realizing the tracking of the taint information in combination with the probe information.

In an embodiment, the actual running information of the target object may be an original bytecode instruction to be loaded and run, so performing the preprocessing of taint tracking on the actual running information of the target object may refer to performing the preprocessing of taint tracking on the actual running information of the target object to obtain a new bytecode instruction after the preprocessing, and taking the new bytecode instruction as the target running information to be loaded after the preprocessing.

Herein, before the new bytecode instruction is executed, the simulation operation of loading and running is performed on the new bytecode instruction to verify the format of the new bytecode instruction. If the verification fails to pass, the new bytecode instruction is directly discarded, that is to say, the preprocessing of the original bytecode instruction is directly discarded.

In this embodiment, the fault tolerance capability is considered. In terms of the fault tolerance capability, since the taint tracking may be completed in a code weaving mode of a bytecode instruction level, and may be directly used without the verification of a compiler, it is easy to cause a Java Virtual Machine (JVM) to fail in a bytecode verification stage, or upward or downward overflowing of a stack space due to an improper stack operation in a running stage. Rather, according to this embodiment, after the new bytecode instruction is obtained after the preprocessing, the simulation work of the loading process of the new bytecode instruction will be performed to verify the format of the new bytecode instruction. If the verification fails to pass, it will directly discard the new bytecode instruction and return to perform the original bytecode instruction before the preprocessing, thereby avoiding the overflow of the stack information of the bytecode instruction and thus the crash of the execution of the target object (e.g., the WEB application) during running due to the overflow of the stack information. Further, the maximum stack space of the bytecode may be increased during the modification of the preprocessing of the original bytecode instruction, which can also avoid the overflow of the stack information.

In an embodiment, when the target object (e.g., the WEB application) is exceptional during running, a pre-intercepting operation is performed on the exceptional stack information, the taint tracking-related stack information is deleted from the stack information after the pre-intercepting, and then the original exception is thrown out.

In this embodiment, the stack information correction capability is considered. In terms of the stack information correction capability, since the agent will be implanted for the taint tracking, in a case where the WEB application runs exceptionally and it is necessary to display the stack information, the stack information displayed by the WEB application may be polluted by the taint marking operation added by the agent, resulting in the discrepancy between the stack information and the source code, which requires the pre-intercepting operation on the exceptional stack information. After the pre-interception, the taint tracking-related stack information is deleted from the stack information, and then the original exception is thrown out, thereby correcting the stack information.

In an embodiment, during running of the WEB application, CPU consumption information corresponding to the WEB application process is collected regularly, and the WEB application will automatically shut off the taint marking operation when the CPU consumption information exceeds a set threshold.

In this embodiment, a CPU fusing operation is adopted, and the pressure control capability of the CPU is considered. In terms of the pressure control capability of the CPU, since the taint tracking implants a large number of extra operations (e.g., the taint marking operation) into the original bytecode instruction during running of the WEB application, and those operations are all performed in series with the WEB application during running, an extra loss of the CPU performance is caused during running of the WEB application. Thus, it is necessary to automatically shut off the taint marking operation regularly when the CPU consumption information is too large. According to this embodiment, the impact on the WEB application in a high CPU occupancy state can be reduced.

In an embodiment, during performing the preprocessing of taint tracking on the original bytecode, the taint marking operation on the built-in class library of the Java Development Kit (JDK) released by a Java developer can be filtered out.

In this embodiment, the pressure control capability of the CPU is considered. In terms of the pressure control capability of the CPU, since the taint tracking implants a large number of extra operations (e.g., the taint marking operation) into the original bytecode instruction during running of the WEB application, and those operations are performed in series with the WEB application during running, an extra loss of the CPU performance is caused during running of the WEB application. The JDK built-in class library belongs to a standard open source library, which may be considered as safe and on which no taint tracking needs to be performed. Thus, the preprocessing of taint tracking may be performed on the original bytecode, to filter out the taint marking operation on the JDK built-in class library. According to this embodiment, the number of the taint tracking operations can be decreased and the CPU pressure during running of the WEB application can be reduced.

In an embodiment, in the case that when the running of the WEB application is detected and the JVM memory is about to overflow, a memory for caching the taint information is automatically released.

In this embodiment, the pressure control capability of the memory is considered. In terms of the pressure control capability of the memory, a large number of caching operations are performed on the taint information by the agent, and the taint information is directly existed in the heap memory space of the WEB application, which increases the pressure of the memory consumption. It is necessary to operate according to the pointer in the memory, and automatically release a memory for caching the taint information when the running of the WEB application is detected and the JVM memory is about to overflow. According to this embodiment, the memory can be released to ensure the normal running of the WEB application.

Application Example:

The vulnerability detection method adopted in this application example is an interactive vulnerability detection method based on the taint tracking. In this application example, the target object to be detected may be a WEB application, and the agent may be implemented by being implanted into the target object (e.g., an agent process may be implanted and executed together with a WEB application process). In this application example, the actual running information of the target object may be a dynamic code to be loaded, such as an original bytecode instruction. In this application example, the preprocessing of taint tracking may be an implanted taint tracking operation, such as the preprocessing that adds a taint marking operation into the original bytecode instruction. After the preprocessing of taint tracking is performed on the original bytecode instruction to be loaded and runs, a new bytecode instruction after the preprocessing can be obtained. The processing flow of this application example applying the embodiment of the present application may include as follows:

I. An end for the agent implanted into the WEB application:

By using the Java Virtual Machine Tool Interface (JVMTI) technology provided by the JVM and in combination with the bytecode compiling technology, the agent can be dynamically implanted into the WEB application process.

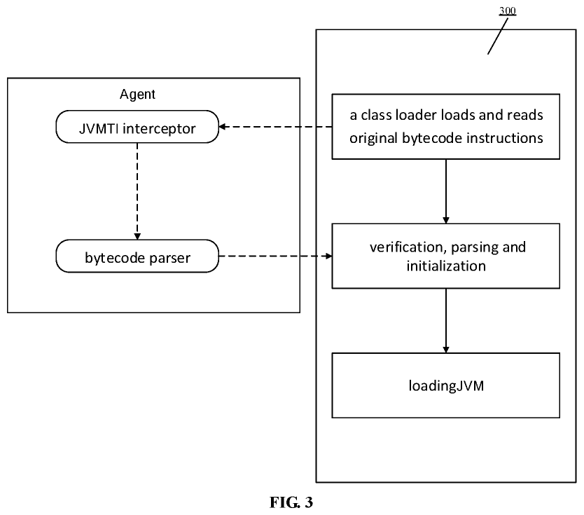

FIG. 3 is a schematic diagram of intercepting and implanting a taint marking operation at an agent end according to an embodiment of the present application. As illustrated in FIG. 3, a procedure of performing the preprocessing on a bytecode instruction and loading a new bytecode instruction, as illustrated in a processing logic 300, may be implemented by an agent, and the taint marking operation may occur before loading and reading an original bytecode instruction based on a class loader (e.g., a JVM class loader). Specifically, the original bytecode instruction to be loaded may be intercepted by the agent (e.g., a JVMTI interceptor implemented at the agent end) before the JVM class loader loads and reads the original bytecode instruction, and a verification, a structural parsing and an initialization may be performed on the original bytecode instruction by the agent (e.g., a bytecode parser implemented at the agent end), so as to fully scan the original bytecode instruction corresponding to each JVM class method, capture the key calling points (e.g., a string operation, an encryption and decryption operation, a codec operation, a stream processing operation, etc.) that will cause a taint infection, replace the original bytecode instructions of these key calling points to add the taint marking operation on the variables, and then hand over the modified new bytecode instructions to the JVM for loading.

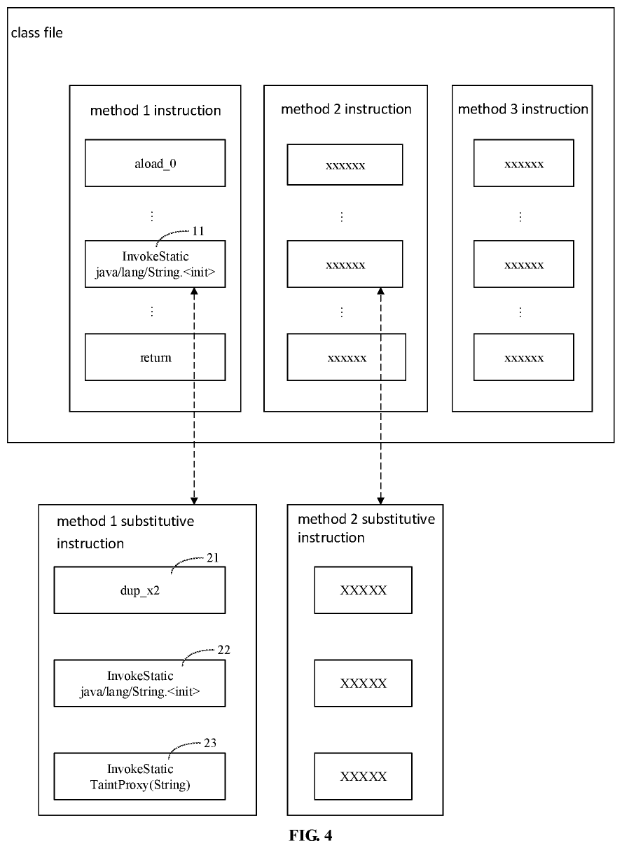

FIG. 4 is a schematic diagram of bytecode parsing and replacement at an agent end according to an embodiment of the present application. As illustrated in FIG. 4, in the process of parsing original bytecode instructions and replacing the original bytecode instructions with new bytecode instructions, the original bytecode instruction corresponding to each JVM class method in a class file is fully scanned. For example, the class file has three JVM class methods, which respectively correspond to a method 1 instruction, a method 2 instruction and a method 3 instruction. Taking the bytecode parsing and replacement of the method 1 instruction as an example, the key calling points (such as original bytecode instructions 11), which will cause a taint infection, need to be tracked. When being captured, the original bytecode instructions 11 are replaced to add the taint marking operation on the variables, to obtain new bytecode instructions. Herein, the new bytecode instructions include a bytecode instruction 21, a bytecode instruction 22 and a bytecode instruction 23; and the bytecode instruction 21 is used to call a stack, the bytecode instruction 22 is used to call the original bytecode instructions 11, the bytecode instruction 23 is a modification result obtained by replacing the called original bytecode instructions 11 and adding the taint marking operation, and then the new bytecode instructions are handed over to the JVM for loading. ‘xxxxxx’ in the method 2 instruction and the method 3 instruction are indicative of undisclosed bytecode instruction types, only for the purpose of illustrating a plurality of JVM class methods and corresponding to the method 1 instruction, the method 2 instruction and the method 3 instruction, respectively.

FIG. 5 is a schematic diagram of an interaction between an agent end and a scanning end according to an embodiment of the present application. As illustrated in FIG. 5, when a WEB application runs till a taint monitoring point for the taint tracking, the taint tracking and a caching operation on the taint information are performed by the agent, and the tracked taint information is cached; when the execution proceeds to a specific probe, the taint information is acquired by the probe and combined with the probe information (e.g., the probe context information, which may be a server type, a database type, request information, etc.) to obtain scanning information, and the scanning information is transmitted to the scanning end, so that the scanner can construct a vulnerability detection request and perform a vulnerability analysis.

II. The other end corresponding to the agent end, i.e., the scanning end:

As illustrated in FIG. 5, the scanning end receives the scanning information which may at least include the taint information and the probe information, analyzes the taint information and the probe information to obtain respective taint information corresponding to the probe information, and constructs a vulnerability detection request according to the taint information and the probe information, to initiate a targeted vulnerability detection request for the WEB application, thereby scanning out any possible vulnerability in the WEB application. A payload factor for the specified vulnerability type may also be customized according to the taint information and the probe information, so as to add the payload factor for the specified vulnerability type into the vulnerability detection request to obtain a first vulnerability detection request, which is sent so that the agent obtains the payload factor through the first vulnerability detection request and trigger the detection of the specified vulnerability type according to the payload factor. In the process of performing the scanning on the WEB application after initiating the vulnerability detection request, the scanning end may continuously receive the taint information and the probe information fed back from the agent, to further identify the existence of vulnerabilities.

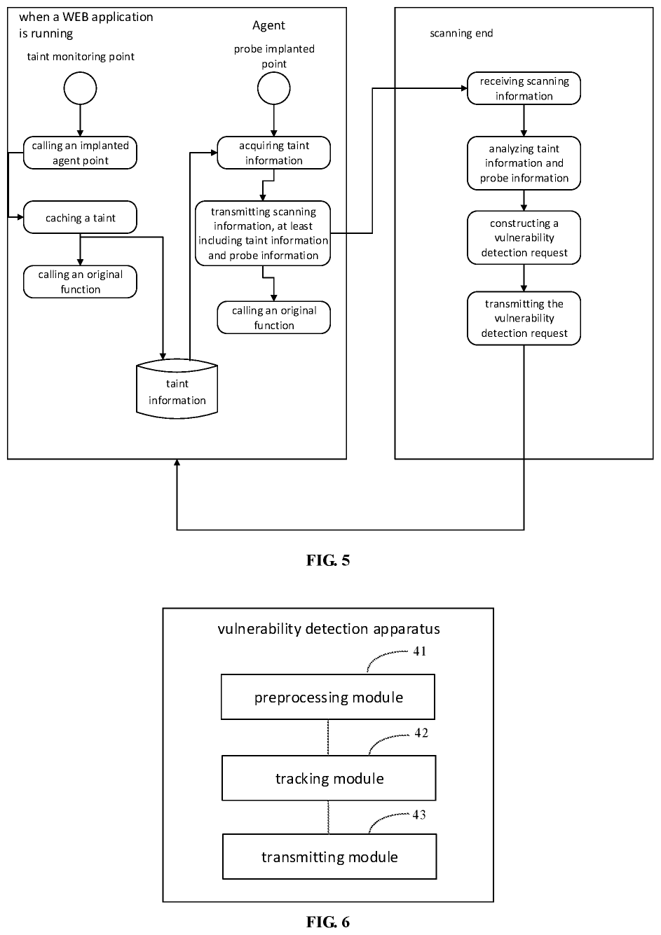

According to an embodiment of the present application, there is provided a vulnerability detection apparatus. FIG. 6 is a schematic structural diagram of the vulnerability detection apparatus according to an embodiment of the present application. As illustrated in FIG. 6, the vulnerability detection apparatus may include: a preprocessing module 41 configured to implant an agent into a target object, and perform, by the agent, preprocessing of taint tracking on actual running information of the target object, to obtain target running information to be loaded after the preprocessing; a tracking module 42 configured to execute the target running information till a taint monitoring point for the taint tracking, to obtain taint information and probe information; and a transmitting module 43 configured to transmit the taint information and the probe information to a scanning end, to construct, at the scanning end, a vulnerability detection request for vulnerability detection, according to the taint information and the probe information.

In an embodiment, the preprocessing module 41 may include: an intercepting submodule configured to intercept the actual running information of the target object before the actual running information of the target object is loaded; and a taint marking submodule configured to add a taint marking operation into the actual running information of the target object, to obtain the target running information.

In an embodiment, the taint marking submodule may further be configured to acquire key calling points in a class method contained in the actual running information of the target object, and replace byte code instructions of the key calling points with the taint marking operation to obtain the target running information. Herein, the key calling point may include a calling point of at least one of a string operation, an encryption and decryption operation, a codec operation and a stream processing operation.

In an embodiment, the device may further include a monitoring module configured to track a transfer process of the taint information inside the target object through the taint marking operation, to monitor vulnerabilities in the taint information.

In an embodiment, the tracking module 42 may further include: a mark acquiring submodule configured to execute the target running information till the taint monitoring point for the taint tracking, to acquire the taint marking operation; and a mark parsing submodule configured to parse the taint marking operation to obtain the taint information and the probe information.

In an embodiment, the mark parsing submodule is configured to parse the taint marking operation to trigger a taint tracking processing and obtain the taint information; and when performing the taint tracking processing till a probe, acquire the probe information.

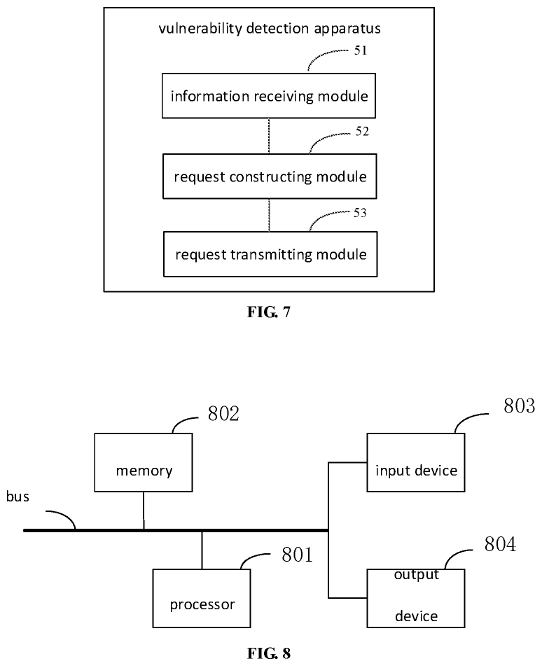

According to an embodiment of the present application, there is provided a vulnerability detection apparatus. FIG. 7 is a schematic structural diagram of the vulnerability detection apparatus according to an embodiment of the present application. As illustrated in FIG. 7, the vulnerability detection apparatus may include: an information receiving module 51 configured to receive taint information and probe information, the taint information and the probe information being obtained from monitoring by an agent implanted into a target object; a request constructing module 52 configured to construct a vulnerability detection request for vulnerability detection according to the taint information and the probe information; and a request transmitting module 53 configured to transmit the vulnerability detection request.

In an embodiment, the device may further include: a feedback receiving module configured to receive a feedback of the vulnerability detection request; and a detection processing module configured to obtain a vulnerability detection result from the feedback of the vulnerability detection request.

In an embodiment, the request transmitting module 53 is further configured to add a load parameter for a detection of a specified vulnerability type into the vulnerability detection request, to obtain a first vulnerability detection request; and transmit the first vulnerability detection request so that the agent obtains the load parameter through the first vulnerability detection request, to trigger the detection of the specified vulnerability type according to the load parameter.

For the functions of the respective modules in each device of the embodiments of the present application, please refer to corresponding descriptions in the above methods, which will not be repeated here.

According to an embodiment of the present application, the present application also provides an electronic device and a readable storage medium.

FIG. 8 is a block diagram of the electronic device for implementing the vulnerability detection method according to the embodiment of the present application. The electronic device may be the deployed apparatus or the agent apparatus aforementioned. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as a personal digital assistant, a cellular telephone, a smart phone, a wearable device, and other similar computing devices. The components shown herein, their connections and relationships, and their functions are by way of example only and are not intended to limit the implementations of the application described and/or claimed herein.

As shown in FIG. 8, the electronic device may include one or more processors 801, a memory 802, and interfaces for connecting the respective components, including high-speed interfaces and low-speed interfaces. The respective components are interconnected by different buses and may be mounted on a common main-board or otherwise as desired. The processor may process instructions executed within the electronic device, including instructions stored in or on the memory to display graphical information of a graphical user interface (GUI) on an external input/output device, such as a display device coupled to the interface. In other implementations, a plurality of processors and/or buses may be used with a plurality of memories, if necessary. Also, a plurality of electronic devices may be connected, each providing some of the necessary operations (e.g., as an array of servers, a set of blade servers, or a multiprocessor system). An example of a processor 801 is shown in FIG. 8.

The memory 802 is a non-transitory computer-readable storage medium provided herein. The memory stores instructions executable by at least one processor to cause the at least one processor to perform the vulnerability detection method provided herein. The non-transitory computer-readable storage medium of the present application stores computer instructions for causing a computer to perform the vulnerability detection method provided herein.

The memory 802, as a non-transitory computer-readable storage medium, may be configured to store non-transitory software programs, non-transitory computer executable programs and modules, such as program instructions/modules corresponding to the vulnerability detection method in the embodiments of the present application (for example, the preprocessing module, the tracking module, the transmitting module and the like illustrated in FIG. 6; for another example, the information receiving module, the request constructing module, the request transmitting module and the like illustrated in FIG. 7). The processor 801 executes various functional applications and data processing of the electronic device by running the non-transitory software programs, instructions and modules stored in the memory 802, that is, implements the vulnerability detection method in the above method embodiments.

The memory 802 may include a program storage area and a data storage area, wherein the program storage area may store an operating system, and an application program required for at least one function; and the data storage area may store data created according to the use of the electronic device, etc. In addition, the memory 802 may include a high speed random access memory, and may also include a non-transitory memory, such as at least one disk storage device, a flash memory device, or other non-transitory solid state storage devices. In some embodiments, the memory 802 may optionally include a memory remotely located with respect to the processor 801, which may be connected, via a network, to the electronic device. Examples of such networks may include, but are not limited to, the Internet, an intranet, a local area network, a mobile communication network and combinations thereof.

The electronic device for the vulnerability detection method may further include an input device 803 and an output device 804. The processor 801, the memory 802, the input device 803, and the output device 804 may be connected by a bus or other means, exemplified by a bus connection in FIG. 8.

The input device 803 may receive input numeric or character information, and generate a key signal input related to a user setting and a functional control of an electronic device. For example, the input device may be a touch screen, a keypad, a mouse, a track pad, a touch pad, a pointer stick, one or more mouse buttons, a track ball, a joystick, and other input devices. The output device 804 may include a display device, an auxiliary lighting device (e.g., a light emitting diode (LED)), a tactile feedback device (e.g., a vibrating motor), etc. The display device may include, but is not limited to, a liquid crystal display (LCD), an LED display, and a plasma display. In some embodiments, the display device may be a touch screen.

Various implementations of the systems and techniques described herein may be implemented in a digital electronic circuit system, an integrated circuit system, an application specific integrated circuit (ASIC), a computer hardware, a firmware, a software, and/or a combination thereof. These various implementations may include an implementation in one or more computer programs, which can be executed and/or interpreted on a programmable system including at least one programmable processor; the programmable processor may be a dedicated or general-purpose programmable processor and capable of receiving and transmitting data and instructions from and to a storage system, at least one input device, and at least one output device.

These computing programs (also referred to as programs, software, software applications, or codes) may include machine instructions of a programmable processor, and may be implemented using high-level procedural and/or object-oriented programming languages, and/or assembly/machine languages. As used herein, the terms “machine-readable medium” and “computer-readable medium” may refer to any computer program product, apparatus, and/or device (e.g., a magnetic disk, an optical disk, a memory, a programmable logic device (PLD)) for providing machine instructions and/or data to a programmable processor, including a machine-readable medium that receives machine instructions as machine-readable signals. The term “machine-readable signal” may refer to any signal used to provide machine instructions and/or data to a programmable processor.

In order to provide an interaction with a user, the system and technology described here may be implemented on a computer having: a display device (e. g., a cathode ray tube (CRT) or a liquid crystal display (LCD) monitor) for displaying information to the user; and a keyboard and a pointing device (e. g., a mouse or a trackball), through which the user can provide an input to the computer. Other kinds of devices can also provide an interaction with the user. For example, a feedback provided to the user may be any form of sensory feedback (e.g., visual feedback, auditory feedback, or tactile feedback); and an input from the user may be received in any form, including an acoustic input, a voice input or a tactile input.

The systems and techniques described herein may be implemented in a computing system (e.g., as a data server) that may include a background component, or a computing system (e.g., an application server) that may include a middleware component, or a computing system (e.g., a user computer having a graphical user interface or a web browser through which a user may interact with embodiments of the systems and techniques described herein) that may include a front-end component, or a computing system that may include any combination of such background components, middleware components, or front-end components. The components of the system may be connected to each other through a digital data communication in any form or medium (e.g., a communication network). Examples of the communication network may include a local area network (LAN), a wide area network (WAN), and the Internet.

The computer system may include a client and a server. The client and the server are typically remote from each other and typically interact via the communication network. The relationship of the client and the server is generated by computer programs running on respective computers and having a client-server relationship with each other.

By adopting the present application, an agent may be implanted into a target object (e.g., a browser webpage or a WEB application program which can access a website), and preprocessing of taint tracking may be performed on actual running information of the target object by the agent, to obtain target running information to be loaded after the preprocessing. By executing the target running information till a taint monitoring point for the taint tracking, taint information and probe information may be obtained, and then transmitted to a scanning end by the agent. Since the taint information and the probe information are obtained from monitoring by the agent, after receiving the taint information and the probe information, the scanning end can perform a targeted vulnerability detection on possible security vulnerabilities in the target object according to a vulnerability detection request constructed by the taint information and the probe information, thereby improving the detection effect of the vulnerability detection.

It should be understood that the steps can be reordered, added or deleted using the various flows illustrated above. For example, the steps described in the present application may be performed concurrently, sequentially or in a different order, so long as the desired results of the technical solutions disclosed in the present application can be achieved, and there is no limitation herein.

The above-described specific embodiments do not limit the scope of the present application. It will be apparent to those skilled in the art that various modifications, combinations, sub-combinations and substitutions are possible, depending on design requirements and other factors. Any modifications, equivalent substitutions, and improvements within the spirit and principles of this application are intended to be included within the scope of this application.

What is claimed is:

1. A vulnerability detection method, comprising:
implanting an agent into a target object, and performing, by the agent, preprocessing of taint tracking on actual running information of the target object, to obtain target running information to be loaded after the preprocessing;
executing the target running information till a taint monitoring point for the taint tracking, to obtain taint information and probe information; and
transmitting the taint information and the probe information to a scanning end, to construct, at the scanning end, a vulnerability detection request for vulnerability detection, according to the taint information and the probe information.

2. The vulnerability detection method according to claim 1, wherein the performing, by the agent, the preprocessing of taint tracking on actual running information of the target object, to obtain target running information to be loaded after the preprocessing, comprises:
intercepting the actual running information of the target object before the actual running information of the target object is loaded; and
adding a taint marking operation into the actual running information of the target object, to obtain the target running information.

3. The vulnerability detection method according to claim 2, wherein the adding the taint marking operation into the actual running information of the target object, to obtain the target running information, comprises:
acquiring key calling points in a class method contained in the actual running information of the target object; and
replacing byte code instructions of the key calling points with the taint marking operation to obtain the target running information,
wherein the key calling point comprises a calling point of at least one of a string operation, an encryption and decryption operation, a codec operation and a stream processing operation.

4. The vulnerability detection method according to claim 2, further comprising:
tracking a transfer process of the taint information inside the target object through the taint marking operation, to monitor vulnerabilities in the taint information.

5. The vulnerability detection method according to claim 2, wherein the executing the target running information till the taint monitoring point for the taint tracking, to obtain taint information and probe information, comprises:
executing the target running information till the taint monitoring point for the taint tracking, to acquire the taint marking operation; and
parsing the taint marking operation to obtain the taint information and the probe information.

6. The vulnerability detection method according to claim 5, wherein the parsing the taint marking operation to obtain the taint information and the probe information, comprises:
parsing the taint marking operation to trigger a taint tracking processing and obtain the taint information; and
when performing the taint tracking processing till a probe, acquiring the probe information.

7. A vulnerability detection method, comprising:
receiving taint information and probe information, the taint information and the probe information being obtained from monitoring by an agent implanted into a target object;
constructing a vulnerability detection request for vulnerability detection according to the taint information and the probe information; and
transmitting the vulnerability detection request.

8. The vulnerability detection method according to claim 7, further comprising:
receiving a feedback of the vulnerability detection request; and
obtaining a vulnerability detection result from the feedback of the vulnerability detection request.

9. The vulnerability detection method according to claim 7, wherein the transmitting the vulnerability detection request comprises:
adding a load parameter for a detection of a specified vulnerability type into the vulnerability detection request, to obtain a first vulnerability detection request; and
transmitting the first vulnerability detection request so that the agent obtains the load parameter through the first vulnerability detection request, to trigger the detection of the specified vulnerability type according to the load parameter.

10. A vulnerability detection apparatus, comprising:
a processor and a memory for storing one or more computer programs executable by the processor,
wherein when executing at least one of the computer programs, the processor is configured to perform operations comprising:
implanting an agent into a target object, and performing, by the agent, preprocessing of taint tracking on actual running information of the target object, to obtain target running information to be loaded after the preprocessing;
executing the target running information till a taint monitoring point for the taint tracking, to obtain taint information and probe information; and
transmitting the taint information and the probe information to a scanning end, to construct, at the scanning end, a vulnerability detection request for vulnerability detection, according to the taint information and the probe information.

11. The vulnerability detection apparatus according to claim 10, wherein, when executing at least one of the computer programs, the processor is configured to further perform operations comprising:
intercepting the actual running information of the target object before the actual running information of the target object is loaded; and
adding a taint marking operation into the actual running information of the target object, to obtain the target running information.

12. The vulnerability detection apparatus according to claim 11, wherein, when executing at least one of the computer programs, the processor is configured to further perform operations comprising:
acquiring key calling points in a class method contained in the actual running information of the target object; and
replacing byte code instructions of the key calling points with the taint marking operation to obtain the target running information,
wherein the key calling point comprises a calling point of at least one of a string operation, an encryption and decryption operation, a codec operation and a stream processing operation.

13. The vulnerability detection apparatus according to claim 11, wherein, when executing at least one of the computer programs, the processor is configured to further perform operations comprising:
tracking a transfer process of the taint information inside the target object through the taint marking operation, to monitor vulnerabilities in the taint information.

14. The vulnerability detection apparatus according to claim 11, wherein, when executing at least one of the computer programs, the processor is configured to further perform operations comprising:
executing the target running information till the taint monitoring point for the taint tracking, to acquire the taint marking operation; and
parsing the taint marking operation to obtain the taint information and the probe information.

15. The vulnerability detection apparatus according to claim 14, wherein, when executing at least one of the computer programs, the processor is configured to further perform operations comprising:
parsing the taint marking operation to trigger a taint tracking processing and obtain the taint information; and
when performing the taint tracking processing till a probe, acquiring the probe information.

16. A vulnerability detection apparatus, comprising:
a processor and a memory for storing one or more computer programs executable by the processor,
wherein when executing at least one of the computer programs, the processor is configured to perform the vulnerability detection method according to claim 7.

17. The vulnerability detection apparatus according to claim 16, wherein, when executing at least one of the computer programs, the processor is configured to further perform operations comprising:
receiving a feedback of the vulnerability detection request; and
obtaining a vulnerability detection result from the feedback of the vulnerability detection request.

18. The vulnerability detection apparatus according to claim 16, wherein, when executing at least one of the computer programs, the processor is configured to further perform operations comprising:
adding a load parameter for a detection of a specified vulnerability type into the vulnerability detection request, to obtain a first vulnerability detection request; and
transmitting the first vulnerability detection request so that the agent obtains the load parameter through the first vulnerability detection request, to trigger the detection of the specified vulnerability type according to the load parameter.

19. A non-transitory computer-readable storage medium storing computer instructions, the computer instructions causing a computer to perform the vulnerability detection method according to claim 1.

20. A non-transitory computer-readable storage medium storing computer instructions, the computer instructions causing a computer to perform the vulnerability detection method according to claim 7.
